(19) United States
(12) Patent Application Publication
(10) Pub. No.: US 2026/0216616 A1
(43) Pub. Date: Jul. 30, 2026

(54) EVAPORATION CHAMBER OF A DEVICE FOR EVAPORATING CHEMICAL COMPOUNDS

(71) Applicant: SEMCO Technologies, CASTRIES (FR)

(72) Inventors: Hervé GUILLON, CASTRIES (FR); Samuel BONNAFOUS, CASTRIES (FR); Jean Manuel DECAMS, CASTRIES (FR)

(21) Appl. No.: 19/149,327

(22) PCT Filed: Dec. 14, 2023
(86) PCT No.: PCT/EP2023/085950

§ 371 Date: Jul. 18, 2025

(30) Foreign Application Priority Data
Jan. 19, 2023 (FR) FR2300518

(51) Int. Cl. B01D 1/00; B01D 1/30

(52) U.S. Cl. CPC B01D 1/0041; B01D 1/0064; B01D 1/30

(57) ABSTRACT

The present description concerns an evaporation chamber (10) comprising a first cavity (30) and a second cavity (50), a first pipe (40), intended for liquid inlet, connecting the outside of the evaporation chamber to the first cavity (30), second pipes (60) connecting the first cavity (30) to the second cavity (50), and a third pipe (70), intended for vapor outlet, connecting the second cavity (50) to the outside of the evaporation chamber, the first pipe (40) and the second pipes (60) opening into a first half of the first cavity (30), the second half of the first cavity (30) comprising no opening.

The present patent application claims priority of French patent application FR23/00518, which will be incorporated herein by reference.

### TECHNICAL FIELD

The present disclosure generally concerns an evaporation chamber of a device for evaporating chemical compounds.

### PRIOR ART

In the field of chemical processes requiring the implementation of vapors of chemical compounds, known as reagents, such as chemical vapor deposition (CVD), atomic layer deposition (ALD), and atomic layer etching (ALE) processes, the implemented reagents, if they are liquid or solid at room temperature and pressure, need to be evaporated.

For this purpose, an evaporator device, which comprises a device for injecting a carrier gas and reagents in liquid form into an evaporation chamber, heating means intended to heat the evaporation chamber to ensure the liquid-to-vapor state change of the reagents, and an outlet connection intended to send the reagent vapors to the treatment plant where they are used, is generally used.

For the proper operation of the treatment plant supplied by the evaporator device, it is generally desirable that no droplets leave the evaporation chamber and reach the treatment plant, and this, for the highest possible injected liquid flow rate.

### SUMMARY OF THE INVENTION

An object of an embodiment is to overcome all or part of the disadvantages of known evaporator devices.

Another object of an embodiment is for the risk of droplet supply from the outlet of the evaporation chamber to be decreased.

Another object of an embodiment is to decrease phenomena of fouling of the evaporator device.

An embodiment provides an evaporation chamber comprising a first cavity and a second cavity, a first pipe, intended for liquid inlet, connecting the outside of the evaporation chamber to the first cavity, second pipes connecting the first cavity to the second cavity, and a third pipe, intended for vapor outlet, connecting the second cavity to the outside of the evaporation chamber, the first pipe and the second pipes opening into a first half of the first cavity, the second half of the first cavity comprising no opening.

According to an embodiment, the evaporation chamber comprises an element for trapping liquid droplets in the first cavity.

According to an embodiment, the trapping element comprises a porous element, in particular a sintered part.

According to an embodiment, the trapping element comprises a texturing of part of or of the entire surface of the first cavity.

According to an embodiment, the trapping element is located opposite the first pipe.

According to an embodiment, the first cavity comprises a first central area continued by a first ring-shaped area, the first pipe opening into the first central area and the second pipes opening into the first ring-shaped area.

According to an embodiment, the trapping element is located in the first central area.

According to an embodiment, the evaporation chamber comprises a filter in the second cavity.

According to an embodiment, the second cavity comprises a second central area continued by a second ring-shaped area, the third pipe opening into the second central area and the second pipes opening into the second ring-shaped area.

According to an embodiment, the filter is located in the second central area.

According to an embodiment, the evaporation chamber comprises a first part, a second part, and a third part, the first part being attached to the second part, the third part being attached to the second part, the first part containing the first pipe, the second part containing the second pipes, the third part containing the third pipe, the first part with the second part delimiting the first cavity, and the second part with the third part delimiting the second cavity.

An embodiment also provides an evaporator device comprising an evaporation chamber such as previously defined, and a device for injecting reagent droplets into the evaporation chamber through the first pipe.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a cross-section view, partial and simplified, of an embodiment of an evaporator device;

FIG. 2 is a cross-section view of FIG. 1 along a plane II-II;

FIG. 3 is a cross-section view of FIG. 1 along a plane III-III;

FIG. 4 is a cross-section view of FIG. 1 along a plane IV-IV;

FIG. 5 is a cross-section view, partial and simplified, of a variant of the evaporator device;

FIG. 6 is a cross-section view, partial and simplified, of another variant of the evaporator device;

FIG. 7 is a cross-section view, partial and simplified, of another embodiment of an evaporator device;

FIG. 8 is a cross-section view of FIG. 7 along a plane VIII-VIII;

FIG. 9 is a cross-section view of FIG. 7 along a plane IX-IX;

FIG. 10 is a cross-section view of FIG. 7 along a plane X-X;

FIG. 11 is a cross-section view, partial and simplified, of another embodiment of an evaporator device; and

FIG. 12 is a cross-section view, partial and simplified, of another embodiment of an evaporator device.

### DESCRIPTION OF EMBODIMENTS

Like features have been designated by like references in the various figures. In particular, the structural and/or functional features that are common among the various embodiments may have the same references and may dispose identical structural, dimensional and material properties. For the sake of clarity, only those steps and elements that are useful for understanding the described embodiments have been shown and are described in detail.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings or to an evaporator device in a normal position of use.

Unless specified otherwise, the expressions “about”, “approximately”, “substantially”, and “in the order of” signify plus or minus 10%, preferably of plus or minus 5%. Unless otherwise specified, ordinal numeral adjectives, such as “first”, “second”, etc., are used only to distinguish elements from one another. In particular, these adjectives do not limit the described embodiments to any specific order of these elements.

In the following description, a material which is a good heat conductor is a material having a thermal conductivity greater than 1 Wm⁻¹K⁻¹, preferably greater than 10 Wm⁻¹K⁻¹.

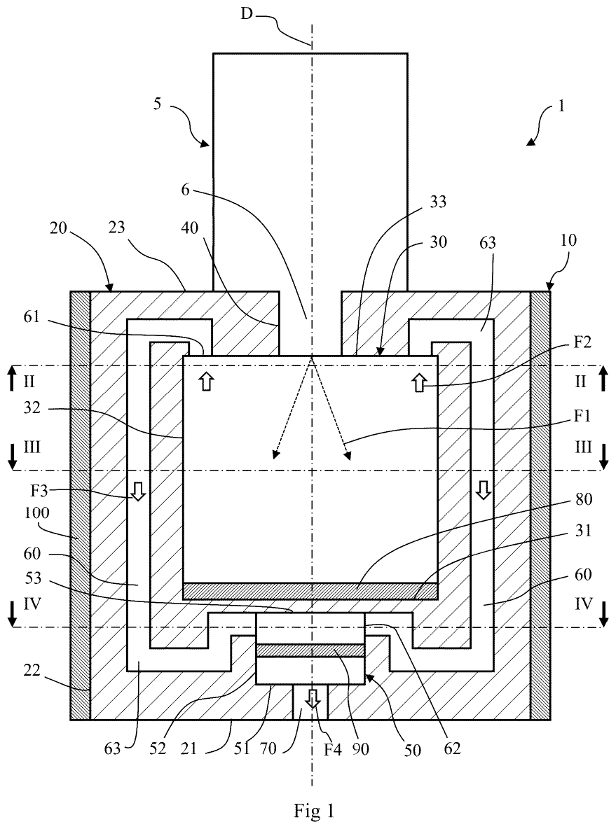

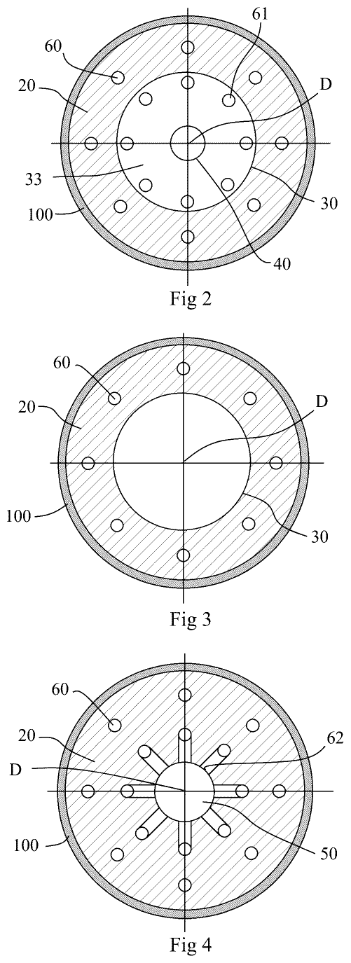

FIG. 1 is a cross-section view, partial and simplified, of an embodiment of an evaporator device 1. FIGS. 2, 3, and 4 each are a cross-section view of FIG. 1 respectively along planes II-II, III-III, and IV-IV.

According to an embodiment, evaporator device 1 comprises an evaporation chamber 10 and a device 5 for injecting liquid into evaporation chamber 10.

Evaporation chamber 10 comprises a body 20 having a bottom wall 21, a side wall 22, and a top wall 23, body 20 further comprising:
a first cavity 30, called upper cavity 30 hereafter, comprising a bottom wall 31, a side wall 32, and a top wall 33, the side wall 32 connecting the bottom wall 31 to the top wall 33;
an access pipe 40 opening at one end onto the top wall 33 of upper cavity 30 and opening at the opposite end onto the top wall 23 of body 20;
a second cavity 50, called lower cavity 50 hereafter, comprising a bottom wall 51, a side wall 52, and a top wall 53, the side wall 52 connecting the bottom wall 51 to the top wall 53;
pipes 60, two pipes 60 being shown in FIG. 1 and eight pipes 60 being shown as an example in FIGS. 2 to 4, each pipe 60 opening at one end 61 into upper cavity 30 and opening at the opposite end 62 into lower cavity 50; and
a pipe 70 opening at one end onto the bottom wall 51 of the lower cavity 50 and opening at the opposite end onto the bottom wall 21 of body 20.

Injection device 5 comprises a head 6 located in access pipe 40, through which liquid or dissolved reagents are injected into upper cavity 30.

According to an embodiment, evaporation chamber 10 comprises a liquid droplet trapping element 80 located in upper cavity 30. According to an embodiment, the distance between the orifice of head 6, from which liquid reagents are injected into upper cavity 30, and trapping element 80 is in the range from 4 cm to 100 cm.

According to an embodiment, evaporation chamber 10 comprises a filter 90 located in lower cavity 50.

Evaporation chamber 10 comprises an element 100 for heating body 20. According to an embodiment, heating element 100 comprises a heating collar surrounding body 20 in contact with the side wall 22 of body 20. According to an embodiment, not shown, heating element 100 comprises heating resistors incorporated in body 20.

According to an embodiment, upper cavity 30 has a rotational symmetry around an axis D. The cross-section plane of FIG. 1 contains axis D. Preferably, in operation, axis D is oriented vertically. Access pipe 40 may also have a rotational symmetry around axis D. In FIG. 1, upper cavity 30 is a cylinder of axis D with a circular base. As a variant, upper cavity 30 may have a shape other than a cylinder, for example, a frustoconical shape of axis D. According to an embodiment, lower cavity 50 has a rotational symmetry around axis D. In FIG. 1, lower cavity 50 is a cylinder of axis D with a circular base.

Each pipe 60 opens into upper cavity 30 in the upper part of upper cavity 30, on the top wall 33 of upper cavity 30, as shown in FIG. 1, or on the upper half of the side wall 32 of upper cavity 30. Each pipe 60 may have a circular cross-section. The number of pipes 60 may vary from 1 to 20. According to an embodiment, each pipe 60 comprises at least one bend 63, and preferably at least two bends 63. According to an embodiment, pipes 60 are evenly distributed around axis D.

According to an embodiment, body 20 is made of metal or of a metal alloy, for example of stainless steel.

The dimensions of evaporation chamber 10 depend on the envisaged application. As an example, the volume of upper cavity 30 is in the range from 10 cm³ to 1,000 cm³. The maximum height between the bottom wall 31 of upper cavity 30 and the top wall 33 of upper cavity 30 is in the range from 10 mm to 500 mm. The diameter of each pipe 60 is in the range from 1 mm to 20 mm. As an example, the volume of lower cavity 50 is in the range from 2 cm³ to 200 cm³. The maximum height between the bottom wall 51 of lower cavity 50 and the top wall 53 of lower cavity 50 is in the range from 4 mm to 250 mm.

The flow rates of liquid or solution injected into evaporation chamber 10 and evaporated are, as an example, in the range from 0.1 g/min to 50 g/min. Pure liquid reagents, liquids in solution in organic solvents or solids in solution in evaporated organic solvents in evaporation chamber 10 are, for example:
metal-organic compounds (where the metal element is directly bonded to a carbon atom) of alkaline earth, rare earth, or transition metal cyclopentadienyl type;
metal-organic compounds of transition metal carbonyl type;
metal-organic compounds of post-transition metal alkyl type;
inorganic compounds (where the metallic element is directly bonded to a non-metal other than carbon) of transition metal, post-transition metal, or metalloid amide or imide type;
inorganic compounds of alkali, alkaline earth, rare earth, transition metal, and post-transition metal β-diketonate type;
inorganic compounds of transition metal, post-transition metal, or metalloid alkoxide type; and
inorganic compounds of transition metal or post-transition metal sulfide or phosphide type.

In the embodiment illustrated in FIG. 1, trapping element 80 is a part separate from body 20, housed in upper cavity 30. Trapping element 80 covers at least the bottom wall 31 of upper cavity 30, and is preferably in contact with the bottom wall 31 of upper cavity 30. In the embodiment illustrated in FIG. 1, trapping element 80 corresponds to a cylindrical part with a circular base of same diameter as the bottom wall 31 of upper cavity 30.

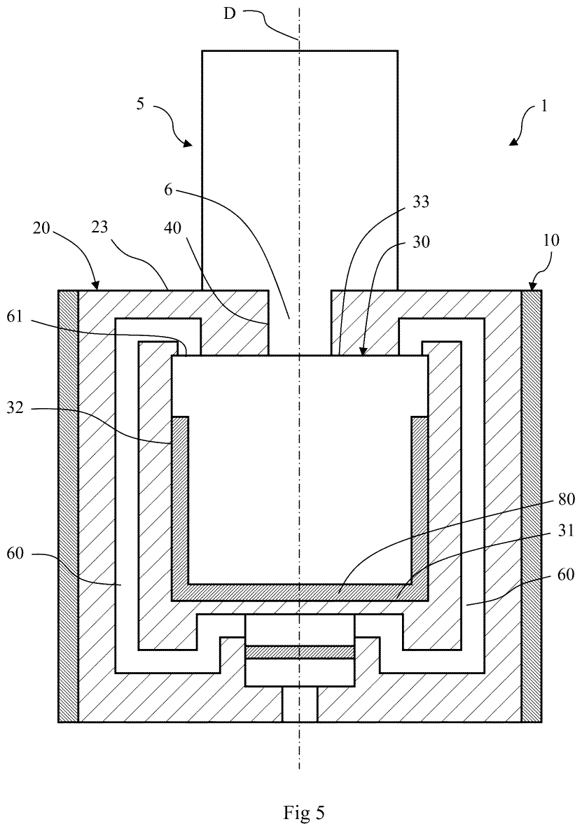

FIG. 5 illustrates a variant of the evaporator device 1 shown in FIG. 1 in which trapping element 80 covers the bottom wall 31 of upper cavity 30 and additionally covers part of the side wall 32 of upper cavity 30, and is preferably in contact with the side wall 32 of upper cavity 30. Trapping element 80 may cover the entire side wall 32 of upper cavity 30.

At least part of trapping element 80 is present opposite head 6 along direction D. According to an embodiment, evaporation chamber 10 comprises an element, not shown in FIG. 1, for fastening trapping element 80 to body 20, for example a ring housed in a groove provided in the side wall 32 of upper cavity 30. Trapping element 80 is made of a material which is a good heat conductor. Further, trapping element 80 is made of a material chemically inert to the reagents to be evaporated. Trapping element 80 may be made of stainless steel. Further, depending on the reagents, trapping element 80 may also be made of nickel or of aluminum.

Trapping element 80 is configured to trap liquid droplets, particularly by absorption and/or adsorption. According to an embodiment, trapping element 80 corresponds to a porous element. As an example, trapping element 80 has an open porosity in the range from 1,000 micrometers (macro-pores) to 2 nanometers (ultramicro-pores). The pores may correspond to spherical, conical, cylindrical cavities, prisms, slots, or have any other geometric shape, interconnected or not (such as for example the structure of sinter, fibrous zeolite, alumina, silica gel, or activated carbon). Trapping element 80 may correspond to a sintered part. The thickness of trapping element 80 is in the range from 0.1 mm to 50 mm. The porosity across the thickness of trapping element 80 may be constant or gradual. Advantageously, the porosity in contact with the chemicals introduced into upper cavity 30 will be greater than that in contact with the surfaces of upper cavity 30. According to an embodiment, trapping element 80 comprises a textured surface so as to exhibit a large surface area of contact with the chemicals introduced into upper cavity 30. As an example, the ratio of the actual surface area to the apparent surface area of trapping element 80 is in the range from 1 to 1,000. According to an embodiment, trapping element 80 comprises a textured surface so that liquid droplets introduced into upper cavity 30 infiltrate into the profile of the surface so as to favor their evaporation. The characteristic size of the pattern of the surface of trapping element 80 is in the range from 1 μm to 10 mm. The textured surface may be obtained by sandblasting, machining, electrical discharge machining, micro-milling, etching, lithography, or laser texturing.

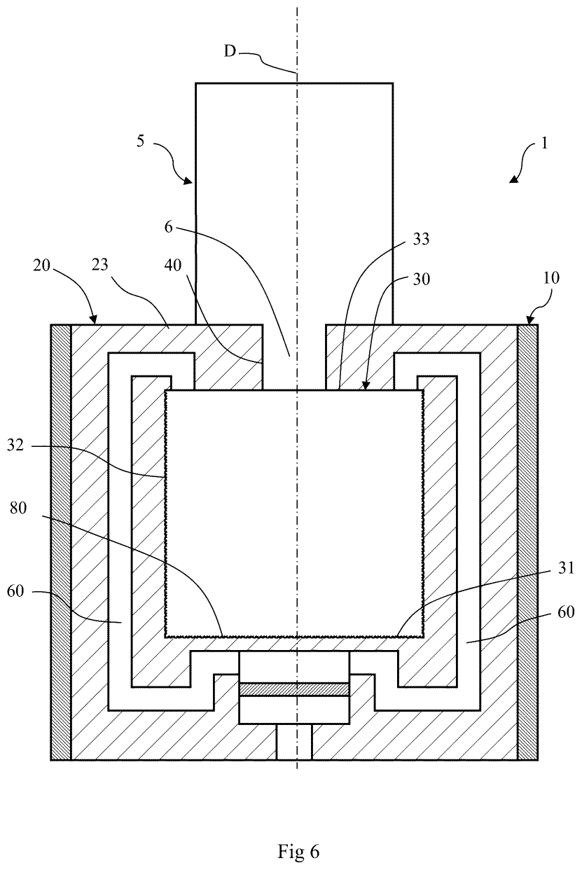

FIG. 6 illustrates a variant of evaporator device 1 in which trapping element 80 is integrated into body 20 and corresponds to a texturing of at least part of the surface of upper cavity 30 so as to exhibit a significant surface area of contact with the chemical elements introduced into upper cavity 30. In FIG. 6, texturing 80 has been schematically shown on the bottom wall 31 and the side wall 32 of upper cavity 30. Texturing 80 may also be present on the top wall 33. As an example, the ratio of the actual surface area to the apparent surface area is in the range from 1 to 1,000. According to an embodiment, the texturing 80 of at least part of the surface of upper cavity 30 enables liquid droplets introduced into upper cavity 30 to infiltrate into the profile of the surface of upper cavity 30 so as to favor their evaporation. The characteristic size of the surface pattern of the texturing 80 of the bottom wall 31, of the side wall 32, and/or of the top wall 33 of upper cavity 30 is in the range from 1 μm to 10 mm. The textured surface may be obtained by sandblasting, machining, electrical discharge machining, micro-milling, etching, lithography, and laser texturing.

Filter 90 is located in lower cavity 50. Filter 90 may correspond to a cylindrical part with a circular base of same diameter as the side wall 52 of lower cavity 50. Filter 90 may be attached to the side wall 52 of lower cavity 50. Filter 90 is made of a material which is a good heat conductor. Further, filter 90 is made of a material chemically inert to the reagents. Filter 90 may be made of stainless steel. Further, depending on the reagents, filter 90 may also be made of nickel or of aluminum. Filter 90 has a filtration threshold in the range from 0.1 μm to 100 μm. Filter 90 may correspond to a sintered part. The thickness of filter 90 is in the range from 0.1 mm to 50 mm.

Evaporation chamber 10 may further comprise at least one pressure sensor, not shown, for example located on outlet pipe 70. Evaporation chamber 10 may further comprise at least one temperature sensor, not shown, for example located in upper cavity 30.

Injection device 5 is configured to deliver a controlled quantity of reagents to be evaporated in evaporation chamber 10. Injection device 5 may supply evaporation chamber 10 with a mixture of a carrier gas and of droplets of the reagents in liquid form, or a mixture of a carrier gas and of a liquid solution containing the reagents in liquid, solid, or gaseous form dissolved in the solution. In particular, the reagents may be pure when they are in liquid form, or they may be dissolved in a solvent, whether they are in liquid or solid form. The injection may be carried out in continuous or pulsed fashion.

In operation, injection device 5 sprays droplets of reagents into upper cavity 30, as illustrated by arrows F1. The temperature and pressure conditions in upper cavity 30 cause the evaporation of the droplets. The reagent vapors leave upper cavity 30 (arrows F2) and are successively driven through pipes 60 (arrows F3), lower cavity 50, and pipe 70 (arrow F4) until they come out of evaporation chamber 10. The temperature and pressure conditions in upper cavity 30 depend in particular on the reagents used. As an example, the temperature in upper cavity 30 is in the range from 15° C. to 300° C. As an example, the pressure inside upper cavity 30 is in the range from 0.1 mbar absolute to 2,000 mbar absolute.

In operation, body 20 is entirely heated by heating element 100. The thermal energy supplied by heating element 100 propagates through body 20 by thermal conduction. Body 20 transmits thermal energy to the gas contained in upper cavity 30, pipes 60, lower cavity 50, and pipe 70. Similarly, trapping element 80 is heated by body 20 and filter 90 is heated by body 20. Conversely, the gas flowing through upper cavity 30, pipes 60, lower cavity 50, and pipe 70 can heat body 20.

The role of trapping element 80 is to trap the injected droplets, and in particular the largest ones, to avoid for the latter to be directly transported to the outlet of evaporation chamber 10. According to the structure of trapping element 80, the trapping of the droplets by trapping element 80 is performed by absorption and/or adsorption (physisorption and/or chemisorption). Indeed, a droplet which is projected onto trapping element 80 does not bounce or burst, but is absorbed and/or adsorbed in trapping element 80. Further, since trapping element 80 is heated, the trapped droplet evaporates. The supply of thermal energy to trapping element 80 is sufficient to compensate for the latent heat of evaporation of the droplets trapped in trapping element 80. The heating of trapping element 80 is obtained by thermal conduction between body 20 and trapping element 80, trapping element 80 being preferably in contact with the bottom wall 31 of upper cavity 30. According to an embodiment, lower cavity 50 is located below the bottom wall 31 of upper cavity 30 so that the passage of hot evaporated gases in lower cavity 50 just below trapping element 80 promotes the heating of the portion of body 20 between trapping element 80 and lower cavity 50. Further, when the injected solution contains soluble, non-volatile contaminants, trapping element 80 takes part in retaining these contaminants and prevents them from escaping outside upper cavity 30. Trapping element 80 does not play the role of a filter, since no it is not crossed by a gas flow.

In the case of solid, low vapor pressure, reagents injected dissolved in a solvent, the evaporation generally takes place by contact with the hot inner surfaces of evaporation chamber 10. The use of a trapping element 80 opposite the injection point of head 6 enables to increase the exchange surface area in upper cavity 30. This enhances the rate of evaporation of these solid reagents adsorbed at the surface of trapping element 80.

Advantageously, upper cavity 30 forms a liquid retention volume, particularly in the event of an incorrect use of evaporator device 1 under thermodynamic conditions which do not enable to integrally evaporate the injected liquid flow and/or cause condensation. It may be too low a temperature, too high a liquid flow rate, or too high a pressure in upper cavity 30. The retention volume formed by upper cavity 30 is used to store the fraction of liquid that cannot be evaporated, so that it is not directly driven to the outlet of evaporation chamber 10.

The use of evaporation chamber 10 is particularly advantageous when the pressure at the outlet of evaporation chamber 10 is low, typically lower than 10 kPa absolute. Indeed, when the pressure is low, the gas flow velocities in evaporation chamber 10 are high, which accordingly decreases the time of residence of droplets in evaporation chamber 10. The droplets thus have less time to be evaporated than if the pressure at the outlet of evaporation chamber 10 is higher. At low pressure, also, larger droplets are ejected, since it is more difficult under these pressure conditions to atomize a liquid into fine droplets.

The bends 63 in each pipe 60 form baffles enabling to block the progress of droplets which may have come out of upper cavity 30. Filter 90 blocks the progress of droplets which may have reached lower cavity 50.

Advantageously, upper cavity 30 enables to decrease phenomena of clogging of filter 90. This allows better control of the evaporation process over time and a spacing of maintenance operations.

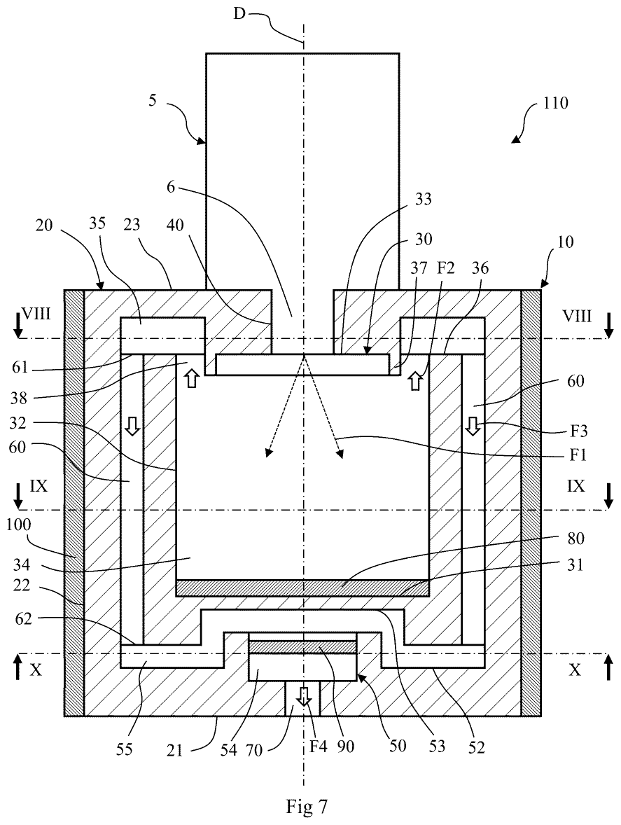

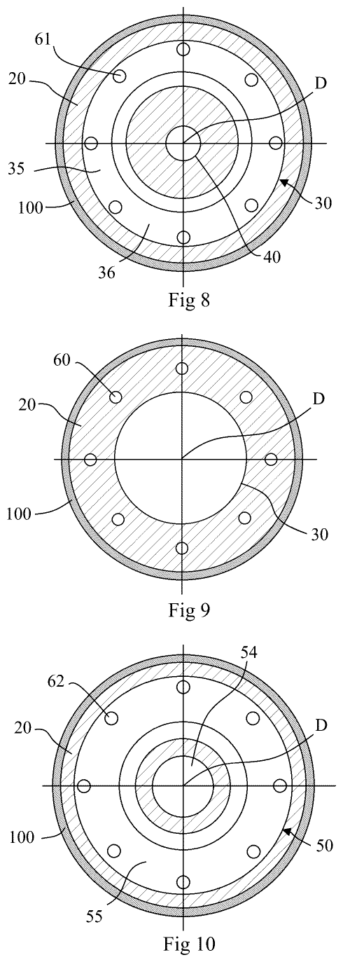

FIG. 7 is a cross-section view, partial and simplified, of another embodiment of an evaporator device 110. FIGS. 8, 9, and 10 each are a cross-section view of FIG. 7 respectively along a plane VIII-VIII, a plane IX-IX, and a plane X-X.

The evaporator device 110 shown in FIG. 7 comprises all the elements of the evaporator device 1 shown in FIG. 1, and further comprises additional features.

Upper cavity 30 comprises a central area 34 continued at the top by a ring-shaped area 35 of axis D. Each pipe 60 opens into ring-shaped area 35. Central area 34 comprises the bottom wall 31 of upper cavity 30, against which trapping element 80 is pressed. According to an embodiment, the side wall 32 of upper cavity 30 comprises a portion 36 substantially perpendicular to axis D and forming the bottom of ring-shaped area 35. The end 61 of each pipe 60 is located on the bottom 36 of ring-shaped area 35.

Lower cavity 50 comprises a central area 54 continued by a ring-shaped area 55 of axis D. Central area 54 comprises the bottom wall 51 of lower cavity 50, and filter 90 is located in central area 54. Each pipe 60 opens into ring-shaped area 55. According to an embodiment, the end 62 of each pipe 60 is located on the top wall 53 of lower chamber 50 in the ring-shaped area 55.

The top wall 33 of upper cavity 30 further comprises a protruding portion 37 projecting towards the bottom wall 31 of upper cavity 30. Together with the side wall 32 of upper cavity 30, protruding portion 36 delimits, with the side wall 32 of upper cavity 30, a ring-shaped channel 38 connecting the central area 34 of upper cavity 30 to the ring-shaped area 35 of upper cavity 30.

In the embodiment shown in FIGS. 7 to 10, pipes 60 have a cylindrical shape and do not comprise the bends 63 shown in FIG. 1. However, the ring-shaped area 35 of upper cavity 30 and the ring-shaped area 55 of lower cavity 50 impose a change in the gas flow direction and thus play the role of baffle like bends 63.

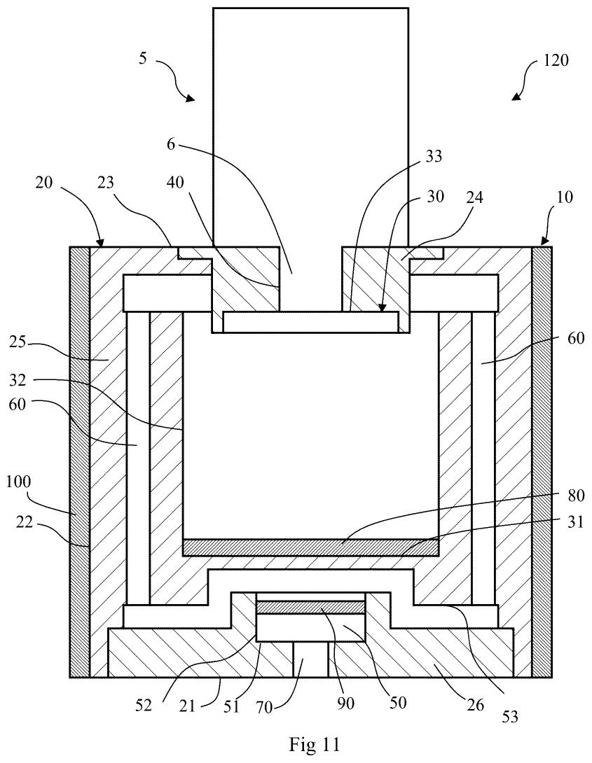

FIG. 11 is a cross-section view, partial and simplified, of another embodiment of an evaporator device 120. The evaporator device 120 shown in FIG. 11 comprises all the elements of the evaporator device 110 shown in FIG. 7. Body 20 is made up of three separate parts, an upper part 24, a central part 25, and a lower part 26. Upper part 24 is attached to central part 25, for example by screwing, and lower part 26 is attached to central part 25, for example by screwing. A gasket of O-ring or flat type, not shown, ensures the sealing between upper part 24 and central part 25 and between central part 25 and lower part 26. The upper part 24 comprises access duct 40 and part of the top wall 33 of upper cavity 30. The lower part 24 comprises pipe 70, the bottom wall 51 of lower cavity 50, and most of the side wall 52 of lower cavity 50. The central part 25 comprises, in particular, pipes 60, the bottom wall 31 of upper cavity 30, and the top wall 53 of lower cavity 50. The forming of body 20 by the three parts 24, 25, and 26 enables to facilitate the forming of body 20, which can be manufactured by machining. It further enables to facilitate the maintenance of evaporation chamber 10, the access to upper cavity 30 being simply obtained by separating upper part 24 and central part 25, and the access to lower cavity 50 and to the pipes being simply obtained by separating lower part 26 and central part 25.

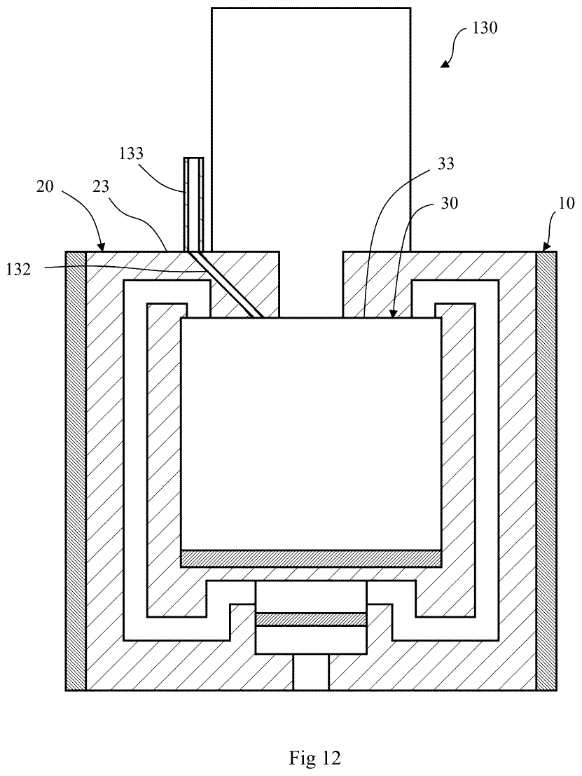

FIG. 12 is a cross-section view, partial and simplified, of another embodiment of an evaporator device 130. The evaporator device 130 shown in FIG. 12 comprises all the elements of the evaporator device 1 shown in FIG. 1 and further comprises an additional pipe 132 opening at one end onto the top wall 33 of upper cavity 30 and opening at the opposite end onto the top wall 23 of body 20. Evaporator device 130 comprises a pipe 133 attached to evaporation chamber 10 and communicating with pipe 132. Tube 133 is connected to a purge gas injection and/or pressure measurement device, not shown. Evaporator device 130 advantageously enables to carry out a purge of evaporation chamber 10 with a neutral gas to evacuate residual vapors which remain in evaporation chamber 10 through a dedicated port, that is, independently of the port through which the reagents to be evaporated are injected into evaporation chamber 10. This may be desirable, in particular when evaporator device 130 is connected to a treatment plant implementing an ALD process.

Various embodiments and variants have been described. Those skilled in the art will understand that certain features of these various embodiments and variants may be combined, and other variants will occur to those skilled in the art. In particular, evaporation chamber 10 may contain trapping element 80, shown in particular in FIGS. 1 and 5, and a surface texturing of evaporation chamber 10, particularly for the walls not covered by trapping element 80. Further, for the evaporation chamber 10 shown in FIG. 7, upper cavity 30 comprises a ring-shaped area and lower cavity 50 comprises a ring-shaped area. As a variant, only upper cavity 30 may comprise the ring-shaped area, with lower cavity 50 not comprising the ring-shaped area, or only lower cavity 50 may comprise the ring-shaped area, with upper cavity 50 not comprising the ring-shaped area.

Finally, the practical implementation of the described embodiments and variants is within the abilities of those skilled in the art based on the functional indications given hereabove.

1. Evaporation chamber comprising a first cavity and a second cavity, a first pipe, intended for liquid inlet, connecting the outside of the evaporation chamber to the first cavity, second pipes connecting the first cavity to the second cavity, and a third pipe, intended for vapor outlet, connecting the second cavity to the outside of the evaporation chamber, the first pipe and the second pipes opening into a first half of the first cavity, the second half of the first cavity comprising no opening.

2. Evaporation chamber according to claim 1, comprising an element for trapping liquid droplets in the first cavity.

3. Evaporation chamber according to claim 2, wherein the trapping element comprises a porous element, in particular a sintered part.

4. Evaporation chamber according to claim 2 or 3, wherein the trapping element comprises a texturing of part of or of the entire surface of the first cavity.

5. Evaporation chamber according to claim 2, wherein the trapping element is located opposite the first pipe.

6. Evaporation chamber according to claim 1, wherein the first cavity comprises a first central area continued by a first ring-shaped area, the first pipe opening into the first central area and the second pipes opening into the first ring-shaped area.

7. Evaporation chamber according to claim 2, wherein the trapping element is located in the first central area.

8. Evaporation chamber according to claim 1, comprising a filter in the second cavity.

9. Evaporation chamber according to claim 1, wherein the second cavity comprises a second central area continued by a second ring-shaped area, the third pipe opening into the second central area and the second pipes opening into the second ring-shaped area.

10. Evaporation chamber according to claim 8, wherein the filter is located in the second central area.

11. Evaporation chamber according to claim 1, comprising a first part, a second part, and a third part, the first part being attached to the second part, the third part being attached to the second part, the first part containing the first pipe, the second part containing the second pipes, the third part containing the third pipe, the first part with the second part delimiting the first cavity, and the second part with the third part delimiting the second cavity.

12. Evaporator device comprising an evaporation chamber according to claim 1, and a device for injecting reagent droplets into the evaporation chamber though the first pipe.

13. Evaporator device according to claim 12, wherein the evaporation chamber comprises an element for trapping said droplets in the second half of the first cavity, the injection device being configured to inject said droplets towards the trapping element.

14. Evaporator device according to claim 13, wherein the distance between the orifice of the injection device, from which said droplets are injected into the first cavity, and the trapping element is in the range from 4 cm to 100 cm.

15. Evaporator device according to claim 12, wherein the injection device is configured to inject into the first cavity a mixture of a carrier gas and of said droplets.
